(19) United States
(12) Patent Application Publication
(10) Pub. No.: US 2017/0098238 A1
(43) Pub. Date: Apr. 6, 2017

(54) METHOD FOR PROVIDING ADVERTISING SERVICE BY MEANS OF ADVERTISING MEDIUM, AND APPARATUS AND SYSTEM THEREFOR

(71) Applicant: SK PLANET CO., LTD., Seongnam-si, Gyeonggi-do (KR)

(72) Inventor: Youngkoan KO, Bucheon-si, Gyeonggi-do (KR)

(21) Appl. No.: 15/311,709

(22) PCT Filed: Jan. 13, 2015
(86) PCT No.: PCT/KR2015/000349

§ 371 Date: Nov. 16, 2016

(30) Foreign Application Priority Data
May 16, 2014 (KR) 10-2014-0058746
May 16, 2014 (KR) 10-2014-0058906

(51) Int. Cl. G06Q 30/02

(52) U.S. Cl. CPC G06Q 30/0244; G06Q 30/0277

(57) ABSTRACT

The present invention relates to a method for providing an advertising service, provided by means of an advertising medium, capable of providing advertisements to users more efficiently, and to an apparatus and a system therefor, the present invention being capable thereby of increasing user satisfaction by: exposing, when advertisement content has been exhausted and advertisement inventory is idle, reminder content generated by a third-party application through the idle advertisement inventory to achieve a similar advertising effect; providing application service and advertising service without incurring user resistance by displaying advertisements with identical user interface/user experience (UI/UX) of an application of the medium; allowing an application developer to produce advertisements with customized UI/UX by means of a convenient method; and allowing an application developer to include an advertisement SDK provided by an advertisement network company in an application.

### TECHNICAL FIELD

The present invention relates to an advertising service and, more particularly, to a method, apparatus and system for providing an advertising service to users more efficiently through an advertising medium.

### BACKGROUND ART

Advertisement is a series of activities for informing potential consumers of information and purchase methods about products and services. Normally advertisement is offered through media such as newspaper, TV, etc.

With rapid growths of technologies, new advertising media have been recently introduced such as digital signage, which is a new outdoor advertising form, capable of controlling the exposed content of advertisements through a digital information display and also interworking with various kinds of portable terminals, and an application or webpage capable of embedding an advertisement module (advertisement SDK) with a software form, receiving advertisement content through the advertisement module, and exposing the received advertisement content through a predefined advertisement inventory.

In case of providing advertisements by means of an advertising medium such as an application or a webpage, the advertisement module is being offered in the form of open source such that a developer can embed the advertisement module in various kinds of application or webpage.

The advertisement module embedded in the application or webpage is typically implemented in the form of software and configured to access a given advertisement server, to obtain advertisement content, and to expose the obtained advertisement content to a predefined advertisement inventory of an advertising medium.

In this case, the advertisement server sequentially delivers registered advertisement contents in response to a request of the advertisement module. Thus, when all the registered advertisement contents are exhausted, no advertisement content is delivered to the advertisement module. Namely, the advertisement inventory is placed in an idle state and this causes a poor utility.

Therefore, required is a method for effectively operating the advertisement inventory without remaining in an empty space even when the advertisement contents are exhausted.

Additionally, a typical inline banner advertisement in an application-based advertising service arouses a user's antipathy. A resultant trend of rise in applications having no inline banner advertisement slows a rate of growth in the market of banner advertisements.

In the advertising industry, a new concept of native advertising is now raised. This is, however, limited to constructing and servicing a user-specific advertisement platform only. In view of this, required is an advanced advertisement platform capable of performing a network function of native advertising with regard to various applications other than a limited native advertising system for a specific application only.

### DISCLOSURE

### Technical Problem

In order to obviate typical problems, the present invention is to provide a method, apparatus and system for offering more efficient advertising effects through an advertising service.

In particular, the first embodiment of this invention is proposed to operate an advertisement inventory more efficiently in providing an advertisement through various advertising media such as a webpage and an application. Specifically, a method for providing reminder content by using an idle advertisement inventory, together with an apparatus therefor, is provided to achieve a similar advertising effect by exposing reminder content created at a third-party application through the idle advertisement inventory when all advertisement contents are exhausted and thus the advertisement inventory is in an idle state.

Additionally, the second embodiment of this invention is proposed to reduce a user's antipathy to a typical, uniform, inline banner advertisement. Namely, this invention is to provide a method for providing an advertisement platform, together with a system and apparatus therefor, which allows an inline banner advertisement platform of offering advertisements to various media applications to be upgraded to a new advertisement platform capable of a native advertising service in parallel with other advertisement platform services.

### Technical Solution

In order to accomplish the above objects, a terminal according to an embodiment of this invention may include a communication unit configured to transmit or receive data to or from an advertisement providing device through a communication network; a memory unit including a reminder content storage area for storing one or more reminder contents; and a control unit configured to receive advertisement content from the advertisement providing device through the communication network during execution of a first application used as an advertisement medium, to output the received advertisement content through an advertisement inventory defined in an execution screen of the first application, to compose the reminder content based on user-related information produced during execution of one or more second applications, to store the composed reminder content in the reminder content storage area, and to output the reminder content stored in the reminder content storage area through the advertisement inventory when the advertisement content is not received.

In the terminal according to an embodiment of this invention, the first application may include an advertisement module configured to send a request for the advertisement content to the advertisement providing device, to receive the advertisement content from the advertisement providing device, to output the received advertisement content through the advertisement inventory defined in the execution screen of the first application, to obtain the reminder content from the reminder content storage area when the advertisement content is not received after the request, and to output the obtained reminder content through the advertisement inventory.

In the terminal according to an embodiment of this invention, the second application may include a reminder support module configured to collect the user-related information produced during the execution of the second application, to compose the reminder content based on the collected user-related information, and to register the composed reminder content in the reminder content storage area.

In the terminal according to an embodiment of this invention, the one or more second applications may include the first application.

In the terminal according to an embodiment of this invention, the reminder content storage area may be a data storage space based on a first input first output (FIFO) rule.

In order to accomplish the above objects, an advertisement module according to an embodiment of this invention may include a storage area connecting unit configured to offer a connecting interface with a reminder content storage area; a reminder content inquiry unit configured to check, in response to a request for an alternative exposure of reminder content, whether the reminder content exists in the reminder content storage area connected through the storage area connecting unit, and if exists, to obtain the reminder content from the reminder content storage area; a reminder content composition unit configured to process the obtained reminder content, based on representation information thereof, in a display form suitable for an advertisement inventory defined in an execution screen of a first application; and a reminder content exposure unit configured to display the processed reminder content on the advertisement inventory.

The advertisement module according to an embodiment of this invention may further include a reminder statistics unit configured to collect execution information about exhaustion and exposure of the reminder content and user reactions to the reminder content through the advertisement inventory, and to transmit the collected information to an advertisement providing device.

The advertisement module according to an embodiment of this invention may further include an advertisement request unit configured to access an advertisement providing device and then request advertisement content at execution of the first application or in response to an advertisement exposure request from the first application; and an advertisement reception unit configured to receive the advertisement content from the advertisement providing device, and if no advertisement content is received, to produce a request for an alternative exposure of the reminder content.

The advertisement module according to an embodiment of this invention may further include an advertisement composition unit configured to compose the advertisement content, delivered from the advertisement reception unit, to meet the advertisement inventory; and an advertisement exposure unit configured to output the composed advertisement content through the advertisement inventory.

The advertisement module according to an embodiment of this invention may further include an advertisement statistics unit configured to collect execution information about an exposure of the advertisement content and user reactions to the exposed advertisement content through the advertisement inventory, and to transmit the collected information to the advertisement providing device.

In order to accomplish the above objects, a reminder support module according to an embodiment of this invention may include an application programmable interface (API) unit configured to provide an application programming interface with a second application for providing reminder content; a storage area connecting unit configured to perform an interface with a reminder content storage area for storing the reminder content; a content managing unit configured to collect user-related information produced at the second application through the API unit, and to compose the reminder content based on the collected user-related information; and a content providing unit configured to send and store the reminder content, created at the content managing unit, to and in the reminder content storage area connected through the storage area connecting unit.

The reminder support module according to an embodiment of this invention may further include a registration unit configured to register a content provider for providing the reminder content in the reminder content storage area.

In order to accomplish the above objects, a method for providing reminder content by using an idle advertisement inventory at an advertisement module may include steps of sending a request for advertisement content to an advertisement providing device in response to an advertisement exposure request; checking whether the advertisement content is received from advertisement providing device; if the advertisement content is received, outputting the received advertisement content through an advertisement inventory defined in an execution screen of a first application defined as an advertisement medium; if the advertisement content is not received, obtaining reminder content from a reminder content storage area; and outputting the obtained reminder content instead of the advertisement content through the advertisement inventory.

The method according to an embodiment of this invention may further include steps of, before the step of obtaining the reminder content, performing a connection with the reminder content storage area; and obtaining an access authority to the reminder content storage area.

The method according to an embodiment of this invention may further include step of, if the advertisement content is received, outputting the received advertisement content through the advertisement inventory

In order to accomplish the above objects, a method for providing reminder content by using an idle advertisement inventory at a reminder support module may include steps of connecting with a reminder content storage area in response to a content registration request; collecting user-related information produced during execution of a second application for providing the reminder content, and then based on the collected user-related information, composing the reminder content; and transmitting the composed reminder content to the reminder content storage area.

In order to accomplish the above objects, a computer-readable storage medium according to an embodiment of this invention may record thereon a program for executing the above method.

In order to accomplish the above objects, a terminal according to an embodiment of this invention may include a communication unit configured to transmit or receive data for providing an advertising service to or from at least one terminal and an advertisement providing device; and a control unit configured to author a form of an advertisement container to which at least one advertisement is exposed, and to provide an application including the advertisement container and an advertisement software development kit (SDK).

The terminal according to an embodiment of this invention may further include a memory unit configured to store the application which includes the advertisement container for outputting an advertisement contained in the application and the advertisement SDK for requesting the advertisement providing device to offer an advertisement and exposing the advertisement, received from the advertisement providing device, to the advertisement container.

In order to accomplish the above objects, an advertisement platform providing system according to an embodiment of this invention may include a terminal configured to author a form of an advertisement container to which at least one advertisement is exposed, and to provide an application including the advertisement container and an advertisement software development kit (SDK); an advertiser terminal configured to create campaign information for provision of the advertisement and to register advertisement resource data according to the created campaign information; and an advertisement providing device configured to perform scheduling for the provision of the advertisement, to identify a target for transmission of the scheduled advertisement to at least one terminal, to provide the advertisement to the target, and to manage log data resulting from the provision of the advertisement.

The advertisement platform providing system according to an embodiment of this invention may further include an advertisement container authoring tool configured to author the advertisement container to which the advertisement is exposed in the application.

The advertisement platform providing system according to an embodiment of this invention may further include the advertisement SDK configured to request the advertisement providing device to offer an advertisement in real time, to expose the advertisement, received from the advertisement providing device, to the advertisement container, and to deliver a processing result for the advertisement to the advertisement providing device.

In order to accomplish the above objects, a method for providing an advertisement platform at a terminal may include steps of authoring a form of an advertisement container for exposing at least one advertisement; composing an application including the advertisement container and an advertisement software development kit (SDK); and providing the composed application.

In the method according to an embodiment of this invention, the advertisement may be an advertisement exposed to an application running in the terminal or to an application of other advertisement providing device.

In order to accomplish the above objects, a computer-readable storage medium according to an embodiment of this invention may record thereon a program for executing steps of authoring a form of an advertisement container for exposing at least one advertisement; composing an application including the advertisement container and an advertisement software development kit (SDK); and providing the composed application.

### Advantageous Effects

According to the present invention, even when all advertisement content are exhausted and thus the advertisement inventory is in an idle state, it is possible to achieve a similar advertising effect by exposing reminder content created at a third-party application through the idle advertisement inventory.

Also, according to this invention, it is possible to provide an application service and an advertising service without incurring user resistance by displaying advertisements in a similar form with a user interface/user experience (UI/UX) of a medium application and also to allow an application developer to produce advertisements with customized UI/UX by means of a convenient method.

And also, this invention allows an application developer to insert an advertisement SDK provided by an advertisement network company in an application, so that an advertisement is requested from an advertisement server when the developed application is executed to thus provide unique advertising material produced conforming to various sizes thereof even if an advertising company is not exposing advertisements produced by means of an advertisement-authoring tool on the screen of a user of the application. Accordingly, this invention can increase user satisfaction.

### DESCRIPTION OF DRAWINGS

FIG. 1 is a diagram illustrating a configuration of an advertisement platform providing system according to embodiments of the present invention.

FIG. 2 is a block diagram illustrating a configuration of a user terminal in an advertising service system according to the first embodiment of the present invention.

FIG. 3 is a block diagram illustrating a detailed configuration of the first application according to the first embodiment of the present invention.

FIG. 4 is a block diagram illustrating a detailed configuration of the second application according to the first embodiment of the present invention.

FIG. 5 is a diagram illustrating a process of providing reminder content in the advertising service system according to the first embodiment of the present invention.

FIG. 6 is a table illustrating a structure of a reminder content storage area for managing reminder contents in the advertising service system according to the first embodiment of the present invention.

FIG. 7 is a flow diagram illustrating a process of registering reminder content by a reminder support module in the advertising service system according to the first embodiment of the present invention.

FIG. 8 is a flow diagram illustrating a process of providing advertisement content by an advertisement module in the advertising service system according to the first embodiment of the present invention.

FIG. 9 is a flow diagram illustrating a process of providing reminder content by the advertisement module in the advertising service system according to the first embodiment of the present invention.

FIG. 10 is a block diagram illustrating a configuration of a developer terminal according to the second embodiment of the present invention.

FIG. 11 is a diagram illustrating a configuration of an application according to the second embodiment of the present invention.

FIG. 12 is a diagram illustrating a configuration of an advertisement container authoring tool according to the second embodiment of the present invention.

FIG. 13 is a diagram illustrating a configuration of an advertisement SDK according to the second embodiment of the present invention.

FIG. 14 is a block diagram illustrating a configuration of an advertisement providing device according to the second embodiment of the present invention.

FIG. 15 is a diagram illustrating a configuration of an advertisement POC according to the second embodiment of the present invention.

FIG. 16 is a flow diagram illustrating an operating method of the developer terminal according to the second embodiment of the present invention.

FIG. 17 is a flow diagram illustrating an operating method of the advertisement providing device according to the second embodiment of the present invention.

FIG. 18 is a flow diagram illustrating an operating method of an advertiser terminal according to the second embodiment of the present invention.

### MODE FOR INVENTION

Hereinafter, embodiments of the present invention will be described with reference to the accompanying drawings. In this disclosure, well known techniques or elements may not be described or illustrated in detail to avoid obscuring the subject matter of the present invention. Also, through the whole drawings, the same or similar reference numerals denote corresponding features consistently.

The terms and words used in the following description and drawings are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

The expression “first”, “second”, etc. used in various embodiments of the present disclosure may modify various elements of such embodiments but does not limit the corresponding elements. The above expressions do not limit the sequence and/or importance of the elements but may be used for distinguishing one element from other elements. For example, without departing from the scope of this invention, a first structural element may be referred to as a second structural element. Similarly, the second structural element also may be referred to as the first structural element.

When it is stated that an element is “coupled to” or “connected to” another element, the element may be directly coupled or connected to another element or a new element may exist between the element and another element. In contrast, when it is stated that an element is “directly coupled to” or “directly connected to” another element, a new element does not exist between the element and another element.

The terms used in describing various embodiments of the present disclosure are only examples for describing a specific embodiment but do not limit the various embodiments of the present disclosure. Singular forms are intended to include plural forms unless the context clearly indicates otherwise. Unless defined differently, all terms used herein, which include technical terminologies or scientific terminologies, have the same meaning as that understood by a person skilled in the art to which the present disclosure belongs. The terms “include”, “comprise”, and “have” as well as derivatives thereof, mean inclusion without limitation.

Hereinafter, a terminal according to embodiments of this invention will be described as a mobile communication device connected to a communication network and capable of offering an advertising service using an application. This is, however, exemplary only and any other type device, such as an information communication device, a multimedia terminal, a wired terminal, a stationary terminal, and an internet protocol (IP) terminal, may be used. Additionally, a terminal or device disclosed herein may employ a mobile phone, a portable multimedia player (PMP), a mobile internet device (MID), a smart phone, a desktop, a tablet PC, a notebook, a netbook, and the like.

Now, an advertisement platform providing system according to embodiments of the present invention will be described.

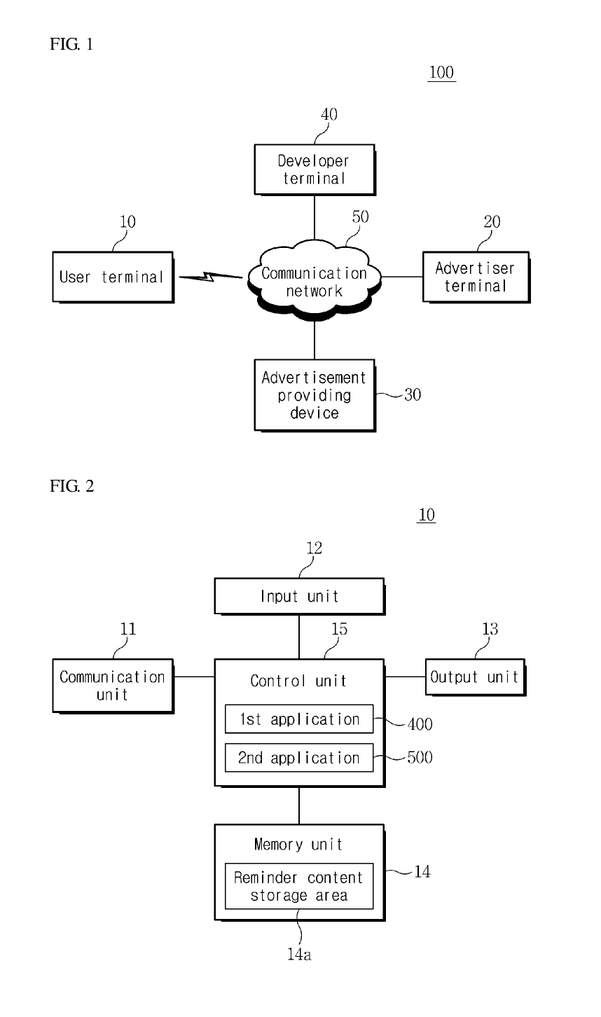

FIG. 1 is a diagram illustrating a configuration of an advertisement platform providing system according to embodiments of the present invention.

Referring to FIG. 1, the advertisement platform providing system 100 according to embodiments of this invention includes a user terminal 10, an advertiser terminal 20, an advertisement providing device 30, a developer terminal 40 for developing an application, and a communication network 50.

A processor equipped in the user terminal 10, the advertiser terminal 20, the advertisement providing device 30, or the developer terminal 40 may process program commands for performing a method of this invention. This processor may be a single-threaded processor in an embodiment and a multi-threaded processor in another embodiment. Further, this processor may process commands stored in a memory or storage.

The communication network 50 performs a series of data transmission and reception operations for transmitting data and exchanging information among the user terminal 10, the advertiser terminal 20, the advertisement providing device 30, and the developer terminal 40. Particularly, the communication network 50 may use wireless communication technique, such as WLAN (Wireless Local Access Network), Wi-Fi, Wibro, Wimax, and HSDPA (High Speed Downlink Packet Access), or wired communication technique, such as Ethernet, xDSL (ADSL, VDSL), HFC (Hybrid Fiber Coaxial cable), FTTC (Fiber To The Curb), and FTTH (Fiber To The Home). Meanwhile, the communication network 300 is not limited to the above examples and may use any other well known technique or to be developed.

The developer terminal 40 communicates with the advertiser terminal 20 or the advertisement providing device 30 through the communication network 50 and thereby transmits or receives all data for providing an advertisement platform. In particular, the developer terminal 40 according to this invention, which is a terminal of a developer who develops an application, authors in advance a form of an advertisement container to which an advertisement is exposed. Additionally, the developer terminal 40 offers an application in which an advertisement container and an advertisement software development kit (SDK) are contained.

The advertiser terminal 20 communicates with the developer terminal 40 or the advertisement providing device 30 through the communication network 50 and thereby transmits or receives all data for providing an advertisement platform. In particular, the advertiser terminal 20 according to this invention creates campaign information for providing an advertisement. Additionally, the advertiser terminal 20 registers resource data of an advertisement according to the created campaign information. At this time, for compatibility with other advertising services, the advertiser terminal 20 may convert an exposure form of an advertisement into a banner form.

The advertisement providing device 30 communicates with the user terminal 10, the advertiser terminal 20 or the developer terminal 40 via the communication network 50 and thereby transmits or receives all data for providing an advertisement platform. In particular, the advertisement providing device 30 according to this invention performs scheduling for providing an advertisement and identifies a target for transmission of a scheduled advertisement to an application user terminal.

The advertisement providing device 30 provides an advertisement to the identified target and also manages log data associated with such provision of an advertisement. Herein, an advertisement includes a certain advertisement exposed to an application running in the user terminal 10 or to an application of any other advertisement providing device.

Through this, an application developer may insert an advertisement SDK, offered by an advertisement network operator, into an application. The developed application may request, when running, an advertisement from the advertisement providing device 30. Even when all advertisement content are exhausted and thus the advertisement inventory is in an idle state, it is possible to achieve a similar advertising effect by exposing reminder content created at a third-party application through the idle advertisement inventory.

Also, it is possible to provide an application service and an advertising service without incurring user resistance by displaying advertisements in a similar form with UI/UX of a medium application and also to allow an application developer to produce advertisements with customized UI/UX by means of a convenient method. And also, this invention allows an application developer to insert an advertisement SDK provided by an advertisement network company in an application, so that an advertisement is requested from an advertisement server when the developed application is executed to thus provide unique advertising material produced conforming to various sizes thereof even if an advertising company is not exposing advertisements produced by means of an advertisement-authoring tool on the screen of a user of the application. Accordingly, this invention can increase user satisfaction.

Next, a process of providing reminder content according to the first embodiment of this invention will be described, based on a detailed configuration and operation of the user terminal 10.

FIG. 2 is a block diagram illustrating a configuration of a user terminal 10 in an advertising service system according to the first embodiment of the present invention.

Referring to FIG. 2, the user terminal 10 according to the first embodiment of this invention may include a communication unit 11, an input unit 12, an output unit 13, a memory unit 14, and a control unit 15.

The communication unit 11 configured to transmit or receive data through the communication network 50 may process data through various communication techniques as well as wired or wireless techniques depending on the type of the communication network 50. Further, the communication unit 11 may use one or more communication techniques for data transmission and reception and thus include a plurality of communication modules based on different communication techniques. In particular, the communication unit 11 according to the first embodiment of this invention accesses the advertisement providing device 30 through the communication network 50, sends a request for advertisement content to the advertisement providing device 30, and receives the requested advertisement content from the advertisement providing device 30.

The input unit 12 is an element for entering user commands or data. The input unit 12 creates various input data including numbers, letters and symbols according to user manipulations and then delivers the created input data to the control unit 15. Also, the input unit 12 delivers a command associated with setting or controlling a function of the user terminal 10 to the control unit 15 according to user manipulations. The input unit 12 may include at least one of a keypad and a touch pad which create an input signal according to user manipulations. Also, the input unit 12 may be formed of all kinds of input tools to be developed as well as typical input tools such as a keyboard, a keypad, a mouse, and a joystick.

The output unit 13 is an element for outputting information created according to the operation of the user terminal 10 so that a user can perceive such information visually, acoustically or tactually. The output unit 13 may include a display unit for outputting visual information, an audio unit (e.g., a speaker) for outputting audible information, and a haptic unit for outputting tactile information. The display unit may be a touch screen and, in this case, may perform wholly or partly the functions of the input unit 13. The audio unit may be a speaker representatively. In particular, the output unit 13 according to the first embodiment of this invention may display an application execution screen and, in response to the operation of an advertisement module contained in an application, displays advertising content or reminder content on a predefined advertisement inventory in the application execution screen.

The memory unit 14 is an element for storing programs and data required for the operation of the user terminal 10. The memory unit 14 basically stores an operating system (OS) program of the user terminal 10 and may further store one or more applications running in the OS environment and data required for or created during the execution of such applications. Particularly, in this invention, the memory unit 14 includes a reminder content storage area 14a which is set in advance for storing reminder content. The reminder content storage area 14a may be set at the initial operation of a reminder support module according to this invention and then shared by the reminder support module and an advertisement module according to this invention. Further, the reminder content storage area 14a is a data storage space based on the first input first output (FIFO) rule by which user-related reminder contents created at one or more second applications are stored in the order of input and, when there is a request of the advertisement module, provided and exhausted in the order of storage. The memory unit 14 may include magnetic media such as a hard disk, a floppy disk and a magnetic tape, optical media such as a compact disk read only memory (CD-ROM) and a digital video disk (DVD), magneto-optical media such as a floptical disk, a ROM, a random access memory (RAM), and a flash memory.

The control unit 15 is an element for controlling the general operation of the user terminal 10. The control unit 15 may be implemented by including a processor such as a microprocessor or a CPU. The control unit 15 may construct an execution environment by triggering the OS program stored in the memory unit 14 when power is turned on. Then, based on the execution environment, the control unit 15 may execute one or more application according to user commands delivered from the input unit 12 and offer a particular function or service to the user. In particular, the control unit 15 of the user terminal 10 according to this invention may execute one or more first applications 400 and one or more second applications 500.

The first application 400 may have the advertisement module according to this invention, and expose advertisement content, received from the advertisement providing device 30 during the execution of application, through a predetermined advertisement inventory, or expose reminder content stored in the reminder content storage area 14a. The second application 500 may have the reminder support module according to this invention and register user-related reminder contents in the reminder content storage area 14a.

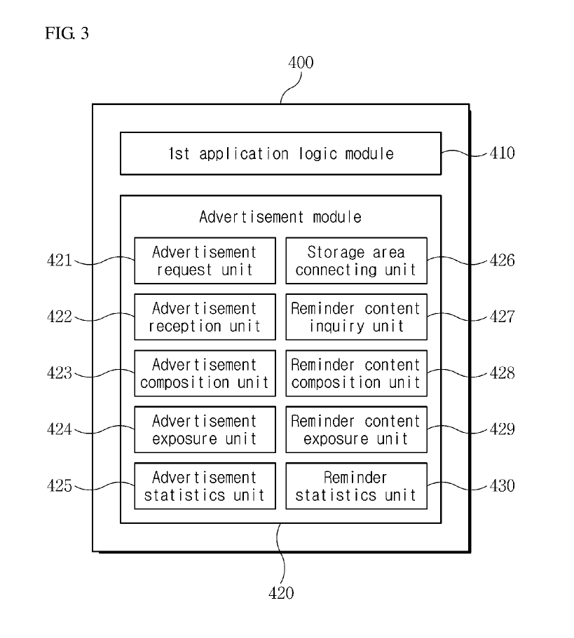

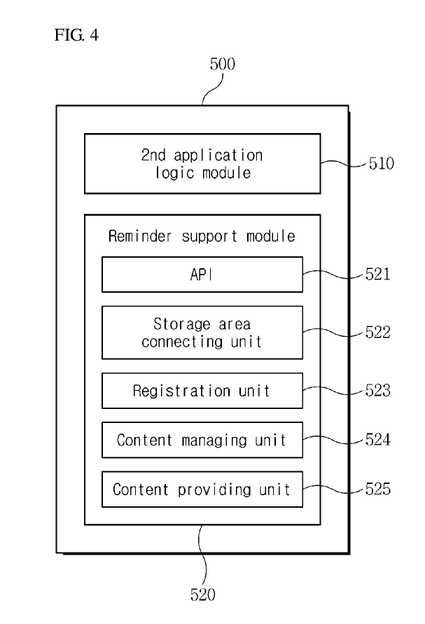

The configuration of the first and second applications 400 and 500 will be described in detail with reference to FIGS. 3 and 4.

FIG. 3 is a block diagram illustrating a module configuration of the first application 400 according to the first embodiment of the present invention. Herein, a module indicates a functional unit and may be implemented in the form of software.

Referring to FIG. 3, the first application 400 may be formed of a first application logic module 410 and an advertisement module 420.

The first application logic module 410 is a logic part which is implemented by an application developer and performs a particular function defined by the application developer. For example, in case of a game application, the first application logic module 410 indicates a logic part for executing a game. The first application logic module 410 has no direct relation with this invention and is implemented differently depending on applications, so that a detailed description will be omitted.

The advertisement module 420 accesses the advertisement providing device 30, receives advertisement content from the advertisement providing device 30, and exposes the received advertisement content to an advertisement inventory defined in a certain area of the execution screen of the first application 400. Particularly, in this invention, if the advertisement inventory is in an idle state because of the reception of no advertisement content from the advertisement providing device 30, the advertisement module 420 may further perform a function of receiving reminder content from the reminder content storage area 14a and then exposing the received reminder content, instead of the advertisement content, through the advertisement inventory.

For this, the advertisement module 420 may include an advertisement request unit 421, an advertisement reception unit 422, an advertisement composition unit 423, an advertisement exposure unit 424, an advertisement statistics unit 425, a storage area connecting unit 426, a reminder content inquiry unit 427, a reminder content composition unit 428, a reminder content exposure unit 429, and a reminder statistics unit 430.

Among them, the advertisement request unit 421, the advertisement reception unit 422, the advertisement composition unit 423, the advertisement exposure unit 424, and the advertisement statistics unit 425 are functional units for processing an advertisement. The advertisement request unit 421 operates at the execution of the first application or in response to an activation request from the first application logic module 410, and then accesses the advertisement providing device 30 so as to request advertisement content. At this time, in order to request advertisement content suitable for the first application or a user thereof, the advertisement request unit 421 may transmit information about the first application, the user thereof, or the user terminal 10. The above request is transmitted to the advertisement providing device 30 through the communication unit 11 under the control of the control unit 15. Next, the advertisement reception unit 422 receives advertisement content from the advertisement providing device 30 and then delivers this to the advertisement composition unit 423. At this time, the advertisement reception unit 422 requests an alternative exposure of reminder content when a response indicating that there is no advertisement content is received from the advertisement providing device 30 or when no advertisement content is received within a given time after the request. If any advertisement content is received by the advertisement reception unit 422, the advertisement composition unit 423 composes the received advertisement content to meet the advertisement inventory of the first application. Also, the advertisement exposure unit 424 outputs and exposes the composed advertisement content through the advertisement inventory. The advertisement statistics unit 425 collects execution information such as the exposure of the advertisement content and user reactions to the exposed advertisement content and then transmits the collected information to the advertisement providing device 30.

Additionally, the storage area connecting unit 426, the reminder content inquiry unit 427, the reminder content composition unit 428, the reminder content exposure unit 429, and the reminder statistics unit 430 are functional units for processing reminder content in case of a failure in processing an advertisement, namely, when there is no advertisement content. These units are activated in response to a request for an alternative exposure of reminder content from the advertisement reception unit 422 and then operate as follows.

The storage area connecting unit 426 offers a connecting interface with the reminder content storage area 14a in response to the above request for an alternative exposure of reminder content. The reminder content inquiry unit 427 checks whether reminder content exists in the reminder content storage area 14a connected through the storage area connecting unit 426, and if exists, obtains reminder content from the reminder content storage area 14a. The reminder content composition unit 428 processes the obtained reminder content, based on representation information thereof, in a display form suitable for the advertisement inventory. The reminder content exposure unit 429 displays the processed reminder content on the advertisement inventory. The reminder statistics unit 430 collects execution information such as the exhaustion and exposure of the reminder content and user reactions to the reminder content and then transmits the collected information to the advertisement providing device 30.

Next, FIG. 4 is a block diagram illustrating a detailed configuration of the second application according to the first embodiment of the present invention.

Referring to FIG. 4, the second application 500 may include a second application logic module 510 and a reminder support module 520.

The second application logic module 510 is a logic part which is implemented by an application developer and performs a particular function defined by the application developer. For example, in case of a game application, the second application logic module 510 indicates a logic part for executing a game. The second application logic module 510 has no direct relation with this invention and is implemented differently depending on applications, so that a detailed description will be omitted.

The reminder support module 520 is an element according to this invention for collecting reminder content and then storing the collected reminder content in the reminder content storage area 14a. The reminder support module 520 may include an application programmable interface (API) unit 521, a storage area connecting unit 522, a registration unit 523, a content managing unit 524, and a content providing unit 525.

The API unit 521 provides an application programming interface with the second application logic module 510. Specifically, the API unit 521 provides an interface for collecting and extracting user-related content (e.g., shopping basket information, bookmark information, etc.) to be used as reminder content.

The storage area connecting unit 522 is an element for performing an interface with the reminder content storage area 14a in which reminder content will be stored.

The registration unit 523 is an element for registering an entity of providing reminder content. Specifically, using an application name, service name or a service provider name of the second application having the reminder support module 520, the registration unit 523 registers an entity of providing reminder content in the reminder content storage area 14a connected through the storage area connecting unit 522. For this, the registration unit 523 may obtain necessary information from the second application logic module 510 through the API unit 521.

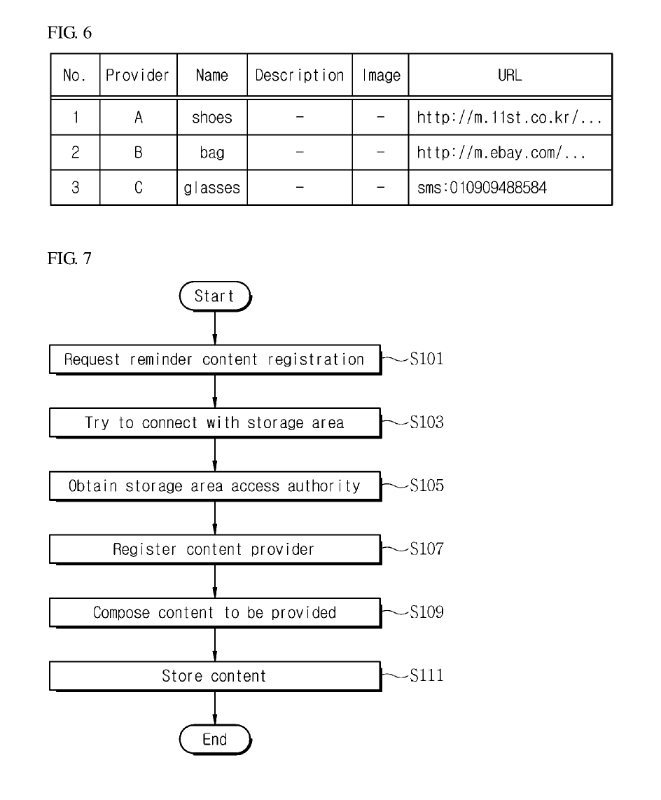

The content managing unit 524 is an element for creating and managing reminder content. Specifically, the content managing unit 524 collects predefined user-related information processed at the second application logic module 510 by interworking with the second application logic module 510 through the API unit 521, and also creates reminder content based on the collected user-related information. More specifically, as shown in FIG. 6, reminder content created by the content managing unit 524 may include one or more of a provider identifier, a content name, a content description, a content representative image, and content URI. Herein, the provider identifier may be an application name or service provider name of the second application, and the content name may be a brand name of corresponding content. In order to obtain such information, the content managing unit 524 may interwork with the second application logic module 510 through the API unit 521.

The content providing unit 525 sends and stores reminder content, created at the content managing unit 524, to and in the reminder content storage area 14a connected through the storage area connecting unit 522, or deletes the stored reminder content from the reminder content storage area 14a.

Although it is described that the advertisement module 420 and the reminder support module 520 are equipped in different applications, the advertisement module 420 and the reminder support module 520 may be equipped in the same application. In this case, the advertisement module 420 and the reminder support module 520 operate independently.

Additionally, the advertisement module 420 and the reminder support module 520 may be offered to application developers in the form of open source. Depending on a selection by an application developer, each application may have one or more of the advertisement module 420 and the reminder support module 520.

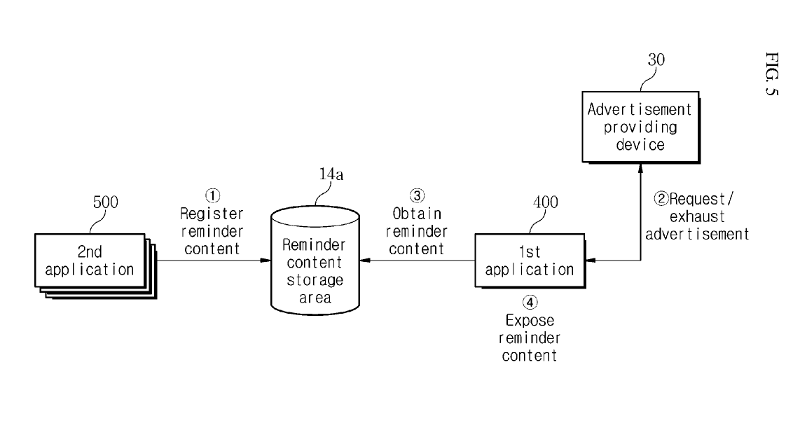

Next, a reminder content providing process by the advertisement module 420 and the reminder support module 520 will be described with reference to FIG. 5.

FIG. 5 is a diagram illustrating a process of providing reminder content in the advertising service system according to the first embodiment of the present invention.

Referring to FIG. 5, when one or more of the second applications 500 are executed, the reminder support module 520 equipped in the second application 500 creates reminder content, based on user-related information produced during the execution of the second application 500, and then stores the created reminder content in the reminder content storage area 14a (\textcircled{1}). Therefore, one or more reminder contents are stored in the reminder content storage area 14a in the order of input. As shown in FIG. 6, the reminder content stored in the reminder content storage area 14a may include one or more of a provider identifier, a content name, a content description, a content representative image, and content URI. Herein, the provider identifier may be an application name or service provider name of the second application, and the content name may be a brand name of corresponding content.

Meanwhile, when the first application 400 is executed, the advertisement module 420 equipped in the first application 400 accesses the advertisement providing device 30, requests advertisement content, and receives a response (\textcircled{2}). At this time, the advertisement providing device 30 may offer advertisement content as a response and, if all advertisement contents are exhausted, may transmit a response indicating that there is no advertisement content.

Therefore, when any advertisement content is received, the advertisement module 420 of the first application 400 exposes the received advertisement content to the advertisement inventory. However, if no advertisement content is received, the advertisement module 420 checks the reminder content storage area 14a and then obtains reminder content (\textcircled{3}).

At this time, the reminder content storage area 14a which is a data storage space based on the FIFO rule offers the first-stored reminder content to the advertisement module 420 of the first application 400 and thus removes the offered reminder content.

The advertisement module 420 of the first application 400 that obtains the reminder content exposes the obtained reminder content to the advertisement inventory (\textcircled{4}).

Accordingly, when the first application 400 is executed, the user of the user terminal 10 can receive advertisement content through the advertisement inventory or related reminder content.

The above-discussed reminder content providing process will be described in detail hereinafter.

FIG. 7 is a flow diagram illustrating a process of registering reminder content by the reminder support module 520 in the advertising service system according to the first embodiment of the present invention.

Referring to FIG. 7, the reminder support module 520 starts the process in response to a content registration request (S101). Herein, the content registration request may occur at the execution of the second application 500 or according as a user or application developer activates the provision of reminder content in setting information of the second application 500.

Then the reminder support module 520 tries to connect with the reminder content storage area 14a for storing reminder content through the storage area connecting unit 522 (S103) and obtains a storage area access authority (S105).

Also, through the registration unit 523, the reminder support module 520 registers a content provider for providing reminder content (S107). At this time, the content provider may be registered using an application name, service name or service provider name of the second application 500.

Thereafter, the reminder support module 520 collects user-related information (e.g., shopping basket setting information) created at the execution of the second application logic module 510, then composes reminder content on the basis of the collected user-related information (S109), and transmits the composed reminder content to the reminder content storage area 14a (S111). Thus, such reminder contents are sequentially stored in the reminder content storage area 14a in the order of transmission.

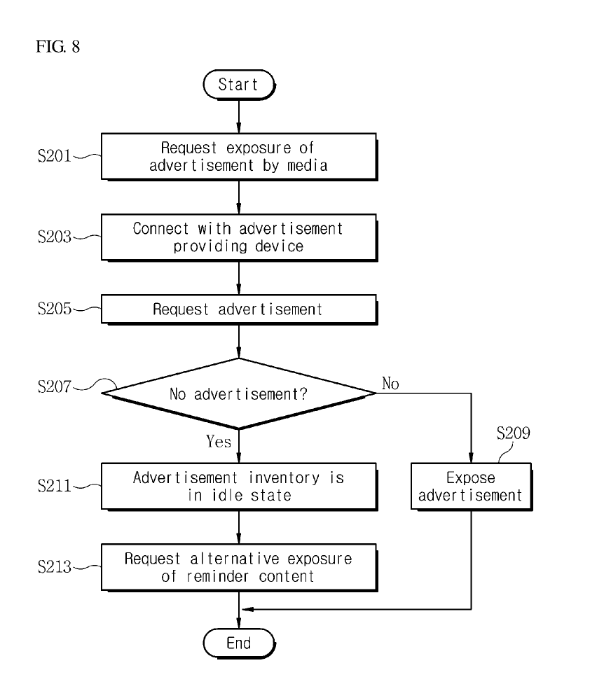

Next, FIG. 8 is a flow diagram illustrating a process of providing advertisement content by the advertisement module 420 in the advertising service system according to the first embodiment of the present invention.

Referring to FIG. 8, the advertisement module 420 equipped in the first application 400 starts the process in response to an advertisement exposure request of an advertising medium (S201). The advertisement exposure request may occur at the initial execution of the first application 400 or when a predetermined event occurs during the execution of the first application logic module 410.

Then the advertisement module 420 performs a connection with the advertisement providing device 30 (S203) and transmits an advertisement content request to the connected advertisement providing device 30 (S205). At this time, the advertisement module 420 may also send user information of the user terminal 10, information about the first application, etc. such that the advertisement providing device 30 can select suitable advertisement content.

Additionally, through the advertisement reception unit 422, the advertisement module 420 checks whether advertisement content is received (S207).

If any advertisement content is received, the advertisement module 420 processes the received advertisement content, outputs the processed content to a predetermined advertisement inventory region in the execution screen of the first application 400, and thereby exposes the advertisement content to the user (S209).

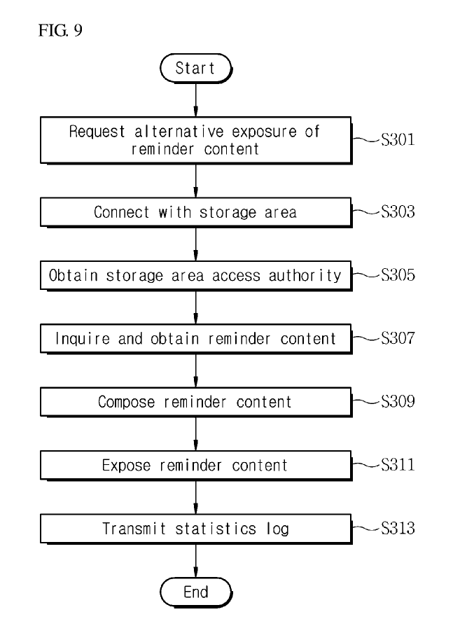

Otherwise, if no advertisement content is received, the advertisement module 420 determines that the advertisement inventory is in an idle state (S211), and performs an alternative exposure of reminder content instead of advertisement content through the advertisement inventory (S213). According to the alternative expose of reminder content, the advertisement module 420 operates as shown in FIG. 9.

FIG. 9 is a flow diagram illustrating a process of providing reminder content by the advertisement module 420 in the advertising service system according to the first embodiment of the present invention.

Referring to FIG. 9, when a request for an alternative exposure of reminder content occurs (S301), the advertisement module 420 tries to connect with the reminder content storage area 14a through the storage area connecting unit 426 and also obtains a storage area access authority for the reminder content storage area 14a (S305).

Then, the advertisement module 420 checks whether reminder content exists in the reminder content storage area 14a connected through the reminder content inquiry unit 427, and if so, obtains the reminder content from the reminder content storage area 14a (S307). At this time, the reminder content storage area 14a which is a data storage space based on the FIFO rule offers the first-stored reminder content to the advertisement module 420 and thus removes the offered reminder content.

Also, through the reminder content composition unit 428, the advertisement module 420 composes the obtained reminder content in a display form suitable for the advertisement inventory, based on representation information of the reminder content (S309). Additionally, through the reminder content exposure unit 429, the advertisement module 420 displays the composed reminder content on the advertisement inventory (S311).

Also, through the reminder statistics unit 430, the advertisement module 420 collects execution information (statistics log) such as the exhaustion and exposure of and user reactions to the displayed reminder content and then transmits the collected information to the advertisement providing device 30 (S313).

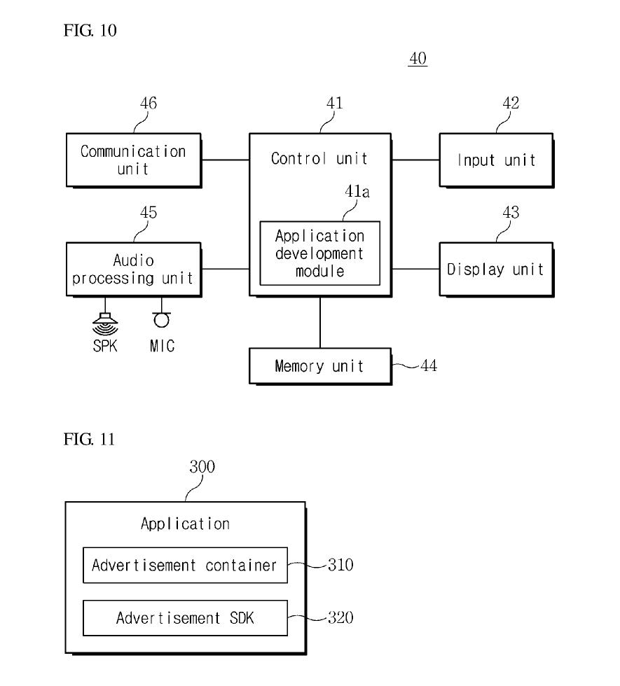

Now, a process of providing an advertisement platform according to the second embodiment of this invention will be described in detail with reference to FIGS. 10 to 18.

FIG. 10 is a block diagram illustrating a configuration of a developer terminal according to the second embodiment of the present invention.

Referring to FIG. 10, the developer terminal 40 according to this invention includes a control unit 41, an input unit 42, a display unit 43, a memory unit 44, an audio processing unit 45, and a communication unit 46. Herein, the control unit 41 includes an application development module 41a.

The input unit 42 receives various kinds of information such as number and letter information and delivers, to the control unit 41, a signal entered in connection with setting of various functions and a function control of the developer terminal 40. Also, the input unit 42 may include at least one of a keypad and a touch pad which create an input signal according to user's touch or manipulations. Also, the input unit 42, together with the display unit 43, may be implemented in the form of a touch panel (or a touch screen) and thus perform input and display functions at the same time. Also, the input unit 42 may be formed of all kinds of input tools to be developed as well as typical input tools such as a keyboard, a keypad, a mouse, and a joystick. In particular, the input unit 42 according to this invention detects all input signals associated with authoring an application for providing an advertisement platform and then delivers the detected signals to the control unit 41.

The display unit 43 displays information about operating states and results of functions of the developer terminal 40. Also, the display unit 43 may display a menu of the developer terminal 40, user data entered by a user, and the like. Herein, the display unit 43 may be formed of a liquid crystal display (LCD), a thin film transistor LCD (TFT-LCD), a light emitting diode (LED), an organic LED (OLED), an active matrix OLED (AMOLED), a retina display, a flexible display, and a 3-dimentional display. In case the display unit 43 is implemented in the form of a touch screen, the display unit 43 may perform wholly or partly the functions of the input unit 42. In particular, the display unit 43 according to this invention displays all screens associated with authoring an application for providing an advertisement platform.

The memory unit 44 for storing data includes a main memory unit and an auxiliary memory unit and stores an application program required for the function or operation of the developer terminal 40. The memory unit 44 may include a program region and a data region. When a certain function is activated in response to a user's request, the developer terminal 40 offers the function by executing corresponding application programs under the control of the control unit 41. In particular, the memory unit 44 according to this invention stores an operating system for booting the developer terminal 10, an application development program, and the like. Also, the memory unit 44 stores an application which includes an advertisement container for outputting an advertisement contained in the application and an advertisement SDK for requesting the advertisement providing device 30 to offer an advertisement and exposing the advertisement, received from the advertisement providing device 30, to the advertisement container.

The audio processing unit 45 performs a function of processing an audio signal in connection with a speaker (SPK) or a microphone (MIC) under the control of the control unit 41. The audio processing unit 45 may convert an analog audio signal, received through the microphone, into a digital signal and then deliver it to the control unit 41. Also, the audio processing unit 45 may convert a digital audio signal, received from the control unit 41, into an analog signal and then output it through the speaker. In particular, the audio processing unit 45 according to this invention outputs a sound effect or the like at the execution of an application for providing an advertisement platform.

The communication unit 46 performs a function of transmitting or receiving data to or from the user terminal 10, the advertiser terminal 20 and the advertisement providing device 30 through the communication network 50. The communication unit 46 may include an RF transmitter to up-convert the frequency of an outgoing signal and to amplify the up-converted signal, and an RF receiver to low-noise-amplify an incoming signal and to down-convert the frequency of the amplified signal. Additionally, the communication unit 46 may include at least one of a wireless communication module (not shown) and a wired communication module (not shown). The wireless communication module is designed to transmit or receive data in a wireless communication manner. In case of using wireless communication, the developer terminal 40 may transmit or receive data to or from the advertiser terminal 20 and the advertisement providing device 30 by using one of an RF module, a wireless RAN module, and a wireless PAN module. Also, the wired communication module is designed to transmit or receive data in a wired communication manner. The wired communication module capable of accessing the communication network 50 through a wire may transmit or receive data to or from the advertiser terminal 20 and the advertisement providing device 30.

The control unit 41 may be a processor for driving an operation system (OS) and respective elements. In particular, the control unit 41 according to embodiments of this invention authors in advance a form of an advertisement container to which an advertisement is exposed. Additionally, the control unit 41 performs a function of offering an application in which an advertisement container and an advertisement SDK are contained.

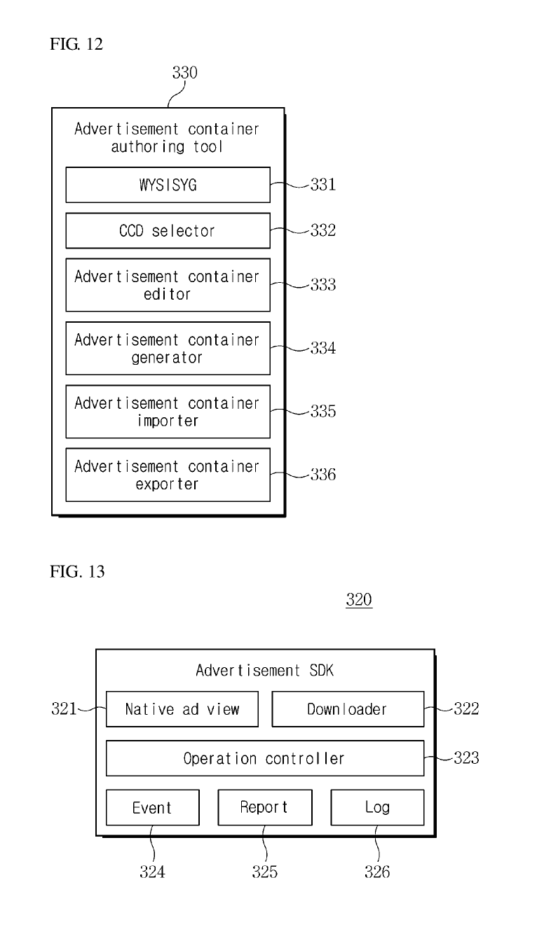

FIG. 11 is a diagram illustrating a configuration of an application according to the second embodiment of the present invention, FIG. 12 is a diagram illustrating a configuration of an advertisement container authoring tool according to the second embodiment of the present invention, and FIG. 13 is a diagram illustrating a configuration of an advertisement SDK according to the second embodiment of the present invention.

Referring to FIGS. 11 to 13, the application 300 according to this invention includes an advertisement container 310 and an advertisement SDK 320. Herein, the advertisement container 310 is a form of displaying an advertisement in the application and authored by an advertisement container authoring tool 330. The advertisement container authoring tool 330 includes a what you see is what you get (WYSIWYG) 331, a creative component definitions (CCD) selector 332, an advertisement container editor 333, an advertisement container generator 334, an advertisement container importer 335, and an advertisement container exporter 336.

An advertisement container template includes CCD, a container definition language (CDL), and an advertisement container template presets. Herein, the CCD defines components of a material and becomes types of data to be entered by the advertiser terminal 20. For example, the CCD includes an image, a title, a description, a landing, a uniform resource locator (URL), and observations (like, share, N/A, etc.). The CDL is a descriptive language for representing an advertisement container in a medium application and indicates the location, size, color, etc. of advertisement material components. The advertisement container template presets are offered through pre-development of advertisement container templates having high usability.

In particular, the WYSIWYG 331 of the advertisement container authoring tool 330 offers a WYSIWYG-based editing environment in which a document being processed by a program is outputted as seen on a display.

The CCD selector 332 offers an editing function for inserting a material component.

The advertisement container editor 333 offers a function for editing the location, color, effect, etc. of layout object for exposing an advertisement.

The advertisement container generator 334 offers a function for distributing an advertisement container file the edit of which is completed through the advertisement container editor 333.

The advertisement container importer 335 offers a function for importing a previous advertisement container.

The advertisement container exporter 336 offers a function for storing a current advertisement container.

Meanwhile, the advertisement SDK 320 includes a native ad view 321, a downloader 322, an operation controller 323, an event 324, a report 325, and a log 326. Herein, the native ad view 321 includes a CDL parser, a CDL renderer, and a view generator. The downloader 322 includes an advertisement downloader, an image downloader, and a video downloader. Further, the advertisement SDK 320 may include developer APIs.

In particular, the CDL parser is a module for reading and parsing an advertisement container definition file.

The CDL renderer is a module for processing the advertisement container parsed through the CDL parser in a drawable form.

The view generator is a module for creating a native view object applicable to a medium application.

The advertisement downloader is a module for receiving the entire advertisement from the advertisement providing device 30.

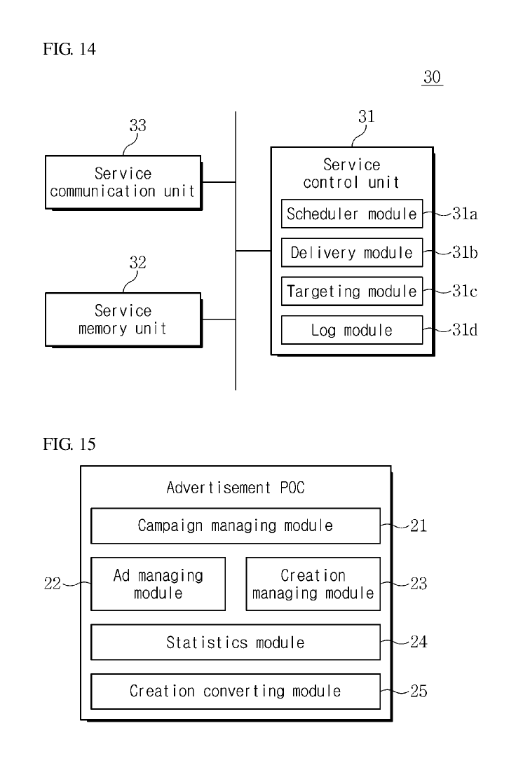

FIG. 14 is a block diagram illustrating a configuration of an advertisement providing device according to the second embodiment of the present invention.

Referring to FIG. 14, the advertisement providing device 30 according to the second embodiment of this invention include a service control unit 31, a service memory unit 32, and a service communication unit 33. Herein, the service control unit 31 includes a scheduler module 31a, a delivery module 31b, a targeting module 31c, and a log module 31d.

The service communication unit 33 communicates with the user terminal 10, the advertiser terminal 20 and the developer terminal 40 through the communication network 50 and thereby transmits or receives data for providing an advertising service.

The service memory unit 32 stores all programs associated with the execution of functions of the advertisement providing device 30. In particular, the service memory unit 32 according to this invention stores a program for scheduling an advertisement, a program for identifying a target, a program for providing an advertisement, and the like.

The service control unit 31 may be a processor for driving an operation system and respective elements. In particular, the service control unit 31 according to the second embodiment of this invention performs scheduling for providing an advertisement. Also, the service control unit 31 identifies a target for transmission of a scheduled advertisement to a terminal using an application and then provides the advertisement to the target. Herein, this advertisement includes a certain advertisement exposed to an application running in the user terminal 10 or to an application of any other advertisement providing device. Also, the service control unit 31 manages log data resulting from the provision of an advertisement.

In order to perform a function for providing an advertisement platform more effectively, the service control unit 31 according to the second embodiment of this invention includes the scheduler module 31a, the delivery module 31b, the targeting module 31c, and the log module 31d.

The scheduler module 31a performs a scheduling function for a registered native advertisement. Also, the delivery module 31b performs a function for delivering a registered native advertisement and a function for defining an interworking protocol standard about advertisement request and response between the advertisement providing device 30 and the advertisement SDK 320.

Additionally, the advertisement providing device 30 as discussed above may be implemented as one or more servers which operate in a server-computing based manner or a cloud manner. In particular, data for the provision of an advertisement platform may be offered through a cloud computing function which may be stored permanently in a cloud computing device on the internet. Herein, the cloud computing refers to technique to service information technology (IT) resources, e.g., hardware (server, storage, network, etc.), software (database, security, web server, etc.), services, and data, virtualized using internet technology to a digital terminal such as a desktop, a tablet computer, a notebook, a netbook, and a smart phone in the on-demand manner.

Meanwhile, a memory equipped in the user terminal 10, the advertiser terminal 20, the advertisement providing device 30 or the developer terminal 40 stores information therein. In an embodiment, the memory is a computer-readable storage medium. In one embodiment, the memory may be a volatile memory unit. In another embodiment, the memory may be a nonvolatile memory unit. In various embodiments, the memory may include a hard disk, an optical disk, or any other mass storage device.

Although this description and drawings illustrate exemplary device elements, the subject matters and functional operations disclosed herein may be implemented by different type digital electronic circuits or implemented by computer software, firmware or hardware including a structure disclosed herein and structural equivalent thereof, or any combination thereof. The subject matters disclosed herein may be implemented by at least one computer program product, namely at least one module regarding computer program commands encoded on a program storage medium so as to control the operation of a device according to this invention or allow execution thereby. A computer-readable medium may be a machine-readable storage device, a machine-readable storage board, a memory device, a machine-readable composition of material affecting wave-type signaling, or a combination thereof.

FIG. 15 is a diagram illustrating a configuration of an advertisement POC according to the second embodiment of the present invention.

Referring to FIG. 15, the advertisement POC according to this invention includes a campaign managing module 21, an advertisement managing module 22, a creation managing module 23, a statistics module 24, and a creation converting module 25. Herein, the advertisement POC performs a function of registering and managing an advertisement.

In particular, the advertisement managing module 22 performs a function of adding a native advertisement dedicated slot.

The creation managing module 23 includes a CCD downloader, which performs a function of registering a native advertisement material. At this time, the CCD downloader registers a thumbnail, a title, a substance, a representative image, and a horizontal image.

The creation converting module 25 performs a function of converting a native advertisement material into a normal banner material based on hyper text markup language 5 (HTML5) for the purpose of utilizing the existing inventory for a normal banner.

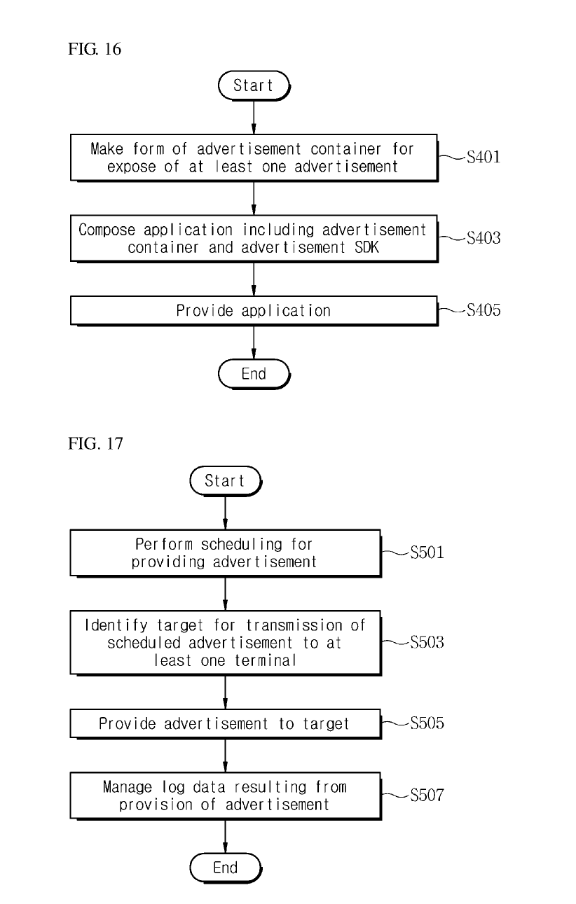

FIG. 16 is a flow diagram illustrating an operating method of the developer terminal according to the second embodiment of the present invention.

Referring to FIG. 16, the developer terminal 40 according to this invention authors the form of an advertisement container for the exposure of at least one advertisement at step S401. Herein, such advertisements include a certain advertisement exposed to an application running in the developer terminal 40 or to an application of any other advertisement providing device. Also, at step S403, the developer terminal 40 composes an application including an advertisement container and an advertisement SDK. Then, at step S405, the developer terminal 40 provides the composed application.

FIG. 17 is a flow diagram illustrating an operating method of the advertisement providing device according to the second embodiment of the present invention.

Referring to FIG. 17, the advertisement providing device 30 according to this invention performs scheduling for providing at least one advertisement at step S501. The, at step S503, the advertisement providing device 30 identifies a target for the transmission of the scheduled advertisement to at least one terminal.

After the target is identified, the advertisement providing device 30 provides an advertisement to the identified target at step S505. Then, at step S507, the advertisement providing device 30 manages log data resulting from the provision of the advertisement.

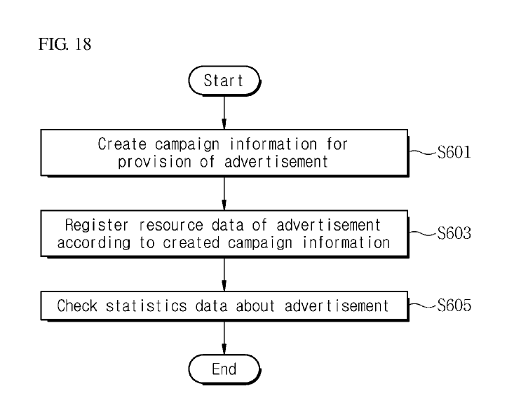

FIG. 18 is a flow diagram illustrating an operating method of an advertiser terminal according to the second embodiment of the present invention.

Referring to FIG. 18, the advertiser terminal 20 according to this invention creates campaign information for the provision of at least one advertisement at step S601. Then, at step S603, the advertiser terminal 20 registers resource data of an advertisement according to the created campaign information. At this time, for compatibility with other advertising services, the advertiser terminal 20 converts an exposure form of the advertisement into a banner form. Thereafter, at step S605, the advertiser terminal 20 checks statistics data about advertisements.

Various techniques disclosed herein may be implemented by different type digital electronic circuits or implemented by computer hardware, firmware, software, or any combination thereof. The subject matters disclosed herein may be implemented by at least one computer program product, namely at least one module regarding computer program commands encoded on a program storage medium so as to control the operation of a device according to this invention or allow execution thereby. A computer program may be written in any form of programming languages including a compiled or interpreted language and developed in any form including a stand-alone program, module, component, subroutine, or other unit suitable for use in computer environments. A computer program can be deployed to be executed on one computer or on multiple computers that are located at one site or distributed across multiple sites and interconnected by a communication network.

Process steps may be performed by one or more programmable processors that execute a computer program so as to perform functions by operating on-input data and producing outputs. Additionally, process steps may be also implemented by a specific-purpose logic circuitry such as a field programmable gate array (FPGA) or an application-specific integrated circuit (ASIC), and also devices may be implemented by them.

The computer-readable storage medium, having recorded thereon, suitable for storing computer program command languages and data, includes magnetic media such as a hard disk, a floppy disk, and a magnetic tape, optical media such as a compact disc read only memory (CD-ROM) and a digital versatile disc (DVD), magneto-optical media such as a floptical disk, and semiconductor memories such as a read only memory (ROM), a random access memory (RAM), a flash memory, an erasable programmable ROM (EPROM), and an electrically EPROM (EEPROM). A processor and memory may be supplemented by or integrated with specific-purpose logical circuit. Program commands may include high-class language codes, which can be executed in a computer by using an interpreter, as well as machine codes made by a compiler. The aforementioned hardware device may be configured to operate as one or more software modules in order to perform the operation of this invention, and vice versa.

While this disclosure contains many specific implementation details, these should not be construed as limitations on the scope of the invention or of what may be claimed, but rather as descriptions of features that may be specific to particular embodiments of particular invention. Certain features that are described in this disclosure in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Although operations are illustrated as being performed in a predetermined order in the drawings, it should not be construed that the operations are required to be performed sequentially or in the predetermined order, which is illustrated to obtain a preferable result, or that all of the illustrated operations are required to be performed. In some cases, multi-tasking and parallel processing may be advantageous. Also, it should not be construed that the division of various system components are required in all types of implementation. It should be understood that the described program components and systems are generally integrated as a single software product or packaged into a multiple-software product.

While this invention has been particularly shown and described with reference to an exemplary embodiment thereof, it will be understood by those skilled in the art that various changes in form and details may be made therein without departing from the spirit and scope of this invention as defined by the appended claims.

### INDUSTRIAL APPLICABILITY

The present invention relates to an advertising service and, more particularly, to a method, apparatus and system for providing the advertising service to users more efficiently through an advertising medium. Accordingly, this invention has a good possibility of sales on the market or business and also has industrial applicability suitable for practical and apparent implementation.

1. A terminal comprising:
a communication unit configured to transmit or receive data to or from an advertisement providing device through a communication network;
a memory unit including a reminder content storage area for storing one or more reminder contents; and
a control unit configured to receive advertisement content from the advertisement providing device through the communication network during execution of a first application used as an advertisement medium, to output the received advertisement content through an advertisement inventory defined in an execution screen of the first application, to compose the reminder content based on user-related information produced during execution of one or more second applications, to store the composed reminder content in the reminder content storage area, and to output the reminder content stored in the reminder content storage area through the advertisement inventory when the advertisement content is not received.

2. The terminal of claim 1, wherein the first application includes an advertisement module configured to send a request for the advertisement content to the advertisement providing device, to receive the advertisement content from the advertisement providing device, to output the received advertisement content through the advertisement inventory defined in the execution screen of the first application, to obtain the reminder content from the reminder content storage area when the advertisement content is not received after the request, and to output the obtained reminder content through the advertisement inventory.

3. The terminal of claim 1, wherein the second application includes a reminder support module configured to collect the user-related information produced during the execution of the second application, to compose the reminder content based on the collected user-related information, and to register the composed reminder content in the reminder content storage area.

4. The terminal of claim 1, wherein the one or more second applications include the first application.

5. The terminal of claim 1, wherein the reminder content storage area is a data storage space based on a first input first output (FIFO) rule.

6. An advertisement module comprising:
a storage area connecting unit configured to offer a connecting interface with a reminder content storage area;
a reminder content inquiry unit configured to check, in response to a request for an alternative exposure of reminder content, whether the reminder content exists in the reminder content storage area connected through the storage area connecting unit, and if exists, to obtain the reminder content from the reminder content storage area;
a reminder content composition unit configured to process the obtained reminder content, based on representation information thereof, in a display form suitable for an advertisement inventory defined in an execution screen of a first application; and
a reminder content exposure unit configured to display the processed reminder content on the advertisement inventory.

7. The advertisement module of claim 6, further comprising:
a reminder statistics unit configured to collect execution information about exhaustion and exposure of the reminder content and user reactions to the reminder content through the advertisement inventory, and to transmit the collected information to an advertisement providing device.

8. The advertisement module of claim 6, further comprising:
an advertisement request unit configured to access an advertisement providing device and then request advertisement content at execution of the first application or in response to an advertisement exposure request from the first application; and
an advertisement reception unit configured to receive the advertisement content from the advertisement providing device, and if no advertisement content is received, to produce a request for an alternative exposure of the reminder content.

9. The advertisement module of claim 8, further comprising:
an advertisement composition unit configured to compose the advertisement content, delivered from the advertisement reception unit, to meet the advertisement inventory; and
an advertisement exposure unit configured to output the composed advertisement content through the advertisement inventory.

10. The advertisement module of claim 9, further comprising:
an advertisement statistics unit configured to collect execution information about an exposure of the advertisement content and user reactions to the exposed advertisement content through the advertisement inventory, and to transmit the collected information to the advertisement providing device.

11. A reminder support module comprising:
an application programmable interface (API) unit configured to provide an application programming interface with a second application for providing reminder content;
a storage area connecting unit configured to perform an interface with a reminder content storage area for storing the reminder content;
a content managing unit configured to collect user-related information produced at the second application through the API unit, and to compose the reminder content based on the collected user-related information; and
a content providing unit configured to send and store the reminder content, created at the content managing unit, to and in the reminder content storage area connected through the storage area connecting unit.

12. The reminder support module of claim 11, further comprising:
a registration unit configured to register a content provider for providing the reminder content in the reminder content storage area.

13. A method for providing reminder content by using an idle advertisement inventory at an advertisement module, the method comprising steps of:
sending a request for advertisement content to an advertisement providing device in response to an advertisement exposure request;
checking whether the advertisement content is received from advertisement providing device;
if the advertisement content is received, outputting the received advertisement content through an advertisement inventory defined in an execution screen of a first application defined as an advertisement medium;
if the advertisement content is not received, obtaining reminder content from a reminder content storage area; and
outputting the obtained reminder content instead of the advertisement content through the advertisement inventory.

14. The method of claim 13, further comprising steps of:
before the step of obtaining the reminder content,
performing a connection with the reminder content storage area; and
obtaining an access authority to the reminder content storage area.

15. The method of claim 13, further comprising step of:
if the advertisement content is received, outputting the received advertisement content through the advertisement inventory.

16. A method for providing reminder content by using an idle advertisement inventory at a reminder support module, the method comprising steps of:
connecting with a reminder content storage area in response to a content registration request;
collecting user-related information produced during execution of a second application for providing the reminder content, and then based on the collected user-related information, composing the reminder content; and
transmitting the composed reminder content to the reminder content storage area.

17. A computer-readable storage medium recording thereon a program for executing the method of claim 13.

18. A terminal comprising:
a communication unit configured to transmit or receive data for providing an advertising service to or from at least one terminal and an advertisement providing device; and
a control unit configured to author a form of an advertisement container to which at least one advertisement is exposed, and to provide an application including the advertisement container and an advertisement software development kit (SDK).

19. The terminal of claim 18, further comprising:
a memory unit configured to store the application which includes the advertisement container for outputting an advertisement contained in the application and the advertisement SDK for requesting the advertisement providing device to offer an advertisement and exposing the advertisement, received from the advertisement providing device, to the advertisement container.

20. An advertisement platform providing system comprising:
a terminal configured to author a form of an advertisement container to which at least one advertisement is exposed, and to provide an application including the advertisement container and an advertisement software development kit (SDK);
an advertiser terminal configured to create campaign information for provision of the advertisement and to register advertisement resource data according to the created campaign information; and
an advertisement providing device configured to perform scheduling for the provision of the advertisement, to identify a target for transmission of the scheduled advertisement to at least one terminal, to provide the advertisement to the target, and to manage log data resulting from the provision of the advertisement.

21. The advertisement platform providing system of claim 20, further comprising:
an advertisement container authoring tool configured to author the advertisement container to which the advertisement is exposed in the application.

22. The advertisement platform providing system of claim 20, further comprising:
the advertisement SDK configured to request the advertisement providing device to offer an advertisement in real time, to expose the advertisement, received from the advertisement providing device, to the advertisement container, and to deliver a processing result for the advertisement to the advertisement providing device.

23. A method for providing an advertisement platform at a terminal, the method comprising steps of:
authoring a form of an advertisement container for exposing at least one advertisement;
composing an application including the advertisement container and an advertisement software development kit (SDK); and
providing the composed application.

24. The method of claim 23, wherein the advertisement is an advertisement exposed to an application running in the terminal or to an application of other advertisement providing device.

25. A computer-readable storage medium recording thereon a program for executing steps of:
authoring a form of an advertisement container for exposing at least one advertisement;
composing an application including the advertisement container and an advertisement software development kit (SDK); and
providing the composed application.

26. A computer-readable storage medium recording thereon a program for executing the method of claim 16.
